(19) United States
(12) Patent Application Publication
(10) Pub. No.: US 2005/0131957 A1
(43) Pub. Date: Jun. 16, 2005

(54) Mobile imagebase

(76) Inventor: Michael David Watkinson, Mississauga (CA)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 10/734,252

(22) Filed: Dec. 15, 2003

(51) Int. Cl. G06F 7/00

(52) U.S. Cl. 707/200

(57) ABSTRACT

A method for synchronizing database records in a school is provided where a master database is populated with student records and photographic images. The master database is loaded onto a central computer and the student records and photographic images are transferred from the master database to a plurality personal digital assistant devices. The Mobile Imagebase provides a conduit for the efficient updating of the student records and monitors the synchronization on a record and user level. In addition, photographic images may be updated on the personal digital assistants at the school.

### BACKGROUND

1. Technical Field

The present invention relates to mobile databases, and more particularly to the use of mobile databases in schools.

2. Description Of Related Art

School administrators have always had a need to readily access student information to efficiently run schools. Teachers and administrators keep records to track the location of students during the day. Schools also keep data associated with students' personal information, such as student photos, home addresses and emergency contacts, etc. The integration of computers and computer databases has aided schools in keeping this information in a readily usable form.

Ready access to this information is crucial for the efficient operation of a school. For example, a principle, or other administrator, will not necessarily know the name of every student. Nor will every teacher know each student's class schedule. And, of course, it cannot be expected that members of a school faculty will know the emergency contact information for each student. All of this information is used on a day-to-day basis in a school. For example, on a large campus, a teacher may see a student smoking from a distance, but not know her name to report her. Or, a teacher may suspect that a particular student is skipping class and not in the proper room during the designated class period. Importantly, a faculty member may need immediate access to emergency contact information if a student is sick or injured.

More recently, the advent of portable computers, or personal digital assistants (“PDAs”), has streamlined school teachers and administrators' ability to instantly access student records and information. Now it is possible for school faculty members to carry databases on PDA devices. Existing systems, however, do not allow for dynamic synchronization of all the information associated with each student. Typically, a master student record database is stored on a server, or other desktop computer in a school house. The various PDA devices are then “synched-up” with the server, whereby any changes reflected in the master database are written into the database in the PDA, and any changes reflected in the PDA are written into the master database. Thus, if a student's personal information changed in the master database it would be updated in the PDA databases when the devices were synched up.

However, there are major shortcomings in the existing systems. First, existing systems rely upon inefficient synchronization procedures that are provided by the PDA manufacturers. Such procedures do not provide for network wide user level synchronization. Also, prior art systems do not allow for on-site dynamic synchronization of image files. That is, existing systems do not allow for the synchronization of student pictures during the synchronization process. Existing systems' inability to provide for the synchronization of image files has many related problems. For example, in order for a school to update its student records database with the most current pictures of its students, a school typically has to send a CD-ROM of the pictures to a vendor; who then, in turn, returns updated database memory cards for the PDAs. This process is inconvenient and time consuming. A school's student population is constantly changing and in flux. It is important for schools to keep their databases current with the changing student populations. If a particular database does not have the current picture data for new students, then that database is deficient. Existing systems do not offer the ability to dynamically update the mobile databases, and require inefficient procedures that ultimately slow down the operation of databases used by schools. Therefore, a heretofore unaddressed need exists in the industry to address the aforementioned deficiencies and inadequacies of the existing state of the art.

### SUMMARY OF THE INVENTION

In one embodiment, a method is provided for synchronizing database records. The method comprises the steps of: (1) storing, on a central computer, demographic data, class schedule data, and image files in a master database; (2) synchronizing the demographic data stored on the central computer with a first database in a mobile computer; and (3) synchronizing the class schedule information stored on the central computer with a second database in the mobile computer.

In another embodiment, a method is provided for for synchronizing database records in a school. The method comprises the steps of: (1) populating a master database with student records and photographic images; (2) loading the master database onto a central computer; (3) transferring the student records and photographic images from the master database to a plurality of mobile computers; and (4) updating the student records and photographic images.

In yet another embodiment, a computer readable medium is provided for causing a computer to: (1) store, in a master database, demographic data, class schedule data, and image files; (2) synchronize the demographic data stored on the master database with a first database in a mobile computer; (3) synchronize the class schedule information stored on the master database with a second database in the mobile computer; and (4) synchronize the image files stored on the master database with a third database in the mobile computer.

Other systems, methods, features, and advantages of the present invention will be apparent to one with skill in the art upon examination of the following drawings and detailed description.

### BRIEF DESCRIPTION OF THE DRAWINGS

Many aspects of the invention can be better understood with reference to the drawings. It should be recognized that components in the drawings are not necessarily to scale, emphasis instead being placed upon clearly illustrating the principles of the present invention. It should also be recognized that like reference numerals in the drawings designate corresponding parts from several views. In this light, the following drawings are provided:

FIG. 1 depicts a network consisting of a central computer and a plurality of PDAs utilizing the Mobile Imagebase;

FIG. 2 depicts the location of the databases used by Mobile Imagebase in the various network units;

FIG. 3 depicts the synchronization of the imagebase database and timetable database;

FIG. 4 depicts the synchronization of the photo database via the export operation;

FIG. 5 depicts the database definitions;

FIG. 6 depicts a logic flowchart of the process of Mobile Imagebase Conduit;

FIG. 7 depicts a logic flowchart of the process of iterating mobile records;

FIG. 8 depicts a logic flowchart of the process of iterating PC records;

and

FIG. 9 depicts a computer that may be utilized by the Mobile Imagebase.

### DETAILED DESCRIPTION OF PREFERRED EMBODIMENTS

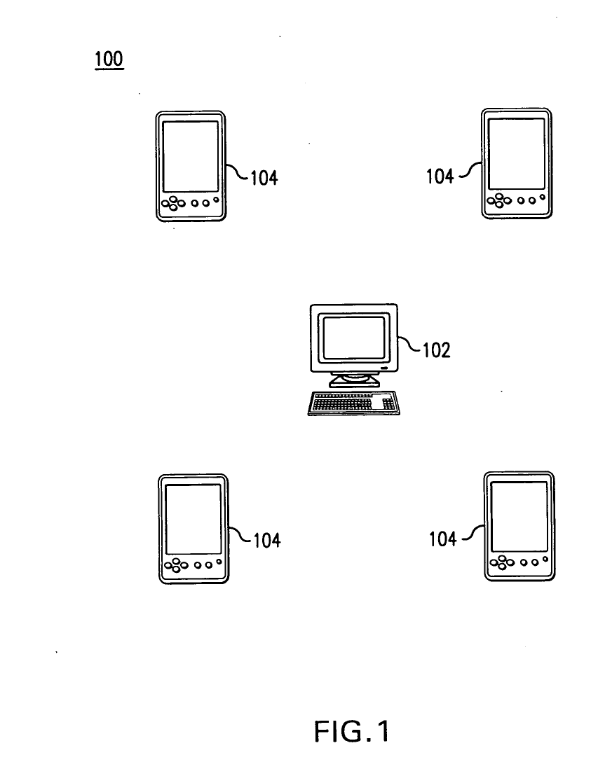

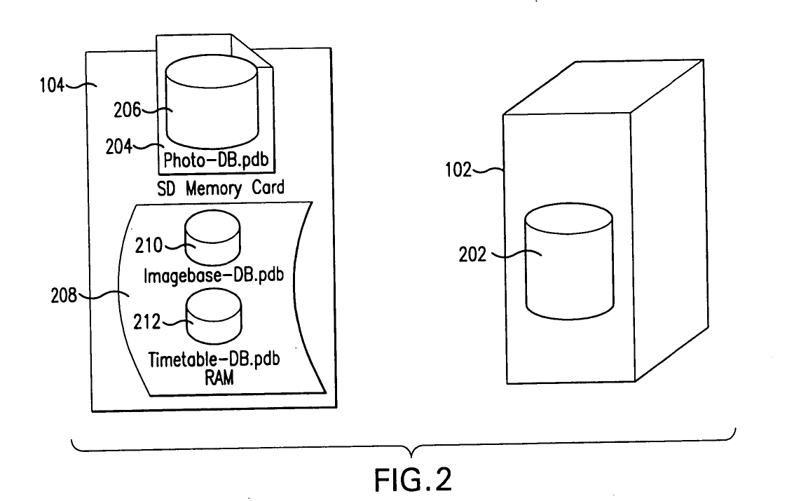

The present invention is a system and methodology utilized to provide schools, or other similar entities, with databases that can be dynamically updated in an efficient manner. FIG. 1 shows a network of a central computer and a plurality of PDAs utilizing the principles disclosed by the Mobile Imagebase, generally designated by the reference numeral 100. The Mobile Imagebase constitutes all the elements of the network 100 that make it possible to dynamically update the databases. The network 100 consists of a central computer 102 and a plurality of mobile computers, or PDAs 104. The central computer 102 may be a standard personal computer or a server computer. The central computer 102 contains Mobile Imagebase's master database, Imagebase Ibase2003.mdb 202 (FIG. 2). It is to be understood that the name of the databases provided herein, e.g., Ibase2003.mdb, is only illustrative and may change from year to year, or from one embodiment to another. The PDAs 104 may be the Palm based PDAs or any other type of PDAs, or other computer, that may utilize a mobile database. It is to be understood that the particular type of central computer 102 or PDA 104 is not to be construed as to limit the scope of the principles of the claimed innovations disclosed herein. In operation, the Mobile Imagebase contains information stored on a database in the central computer 102 which is synchronized with databases stored on the PDAs 104. In one embodiment, the information includes student images, demographic data and class schedule information, as discussed below.

With reference now to FIG. 2 of the drawings, there is illustrated therein a block diagram depicting the location of the databases that may be utilized by various hardware components of the Mobile Imagebase, generally designated by the reference numeral 200. The Mobile Imagebase utilizes the Imagebase Ibase2003.mdb 202. In one embodiment, the Imagebase Ibase2003.mdb 202 may be a Microsoft Access database. The Imagebase Ibase2003.mdb 202 resides on the central computer 102 and can be shared by multiple users in a networked environment. In addition, The Imagebase Ibase2003.mdb 202 contains demographic data, timetable information and student images. The Mobile Imagebase also utilizes a collection of three database files (tables) that reside on the PDA 104. The files are the timetable-db.pdb 212, imagebase-db.pdb 210 and photo-db.pdb 206. All three database tables may be written and sorted in order of student number. The student number value represents the database key which allows records to be quickly accessed using a sort algorithm which may require an average of NlogN iterations.

The photo-db.pdb 206 includes student images, which may be compressed into a bitmap format. The photo-db.pdb 206 may be stored on a secured digital memory card 204. In other embodiments the Mobile Imagebase may store the photo-db.pdb 206 onto a compact flash or memory stick. The imagebase-db.pdb 210 includes demographic data such as a student number, the student's first name, a student's last name, the student's grade, home room, address, emergency contact information, etc. The timetable-db.pdb 212 includes class schedule information which may include the period, subject, room and teacher.

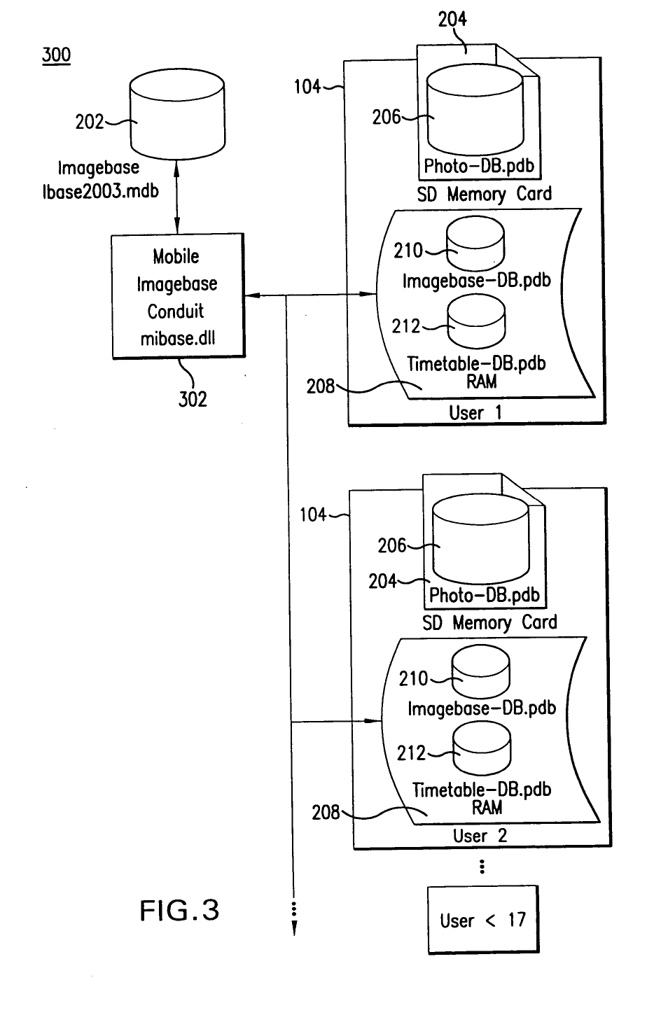

The imagebase-db.pdb 210 and timetable-db.pdb 212 are RAM based databases. That is, the information from these databases are loaded into the RAM 208 of the PDA 104. The imagebase-db.pdb 210 and timetable-db.pdb 212 may be written to by the user to reflect changes that need to be recorded in the database. For example, a teacher may wish to update a student's profile in the database by updating the student's emergency contact information, or a student's schedule may change and the teacher may wish to update the student's class schedule. This may be done via the imagebase-db.pdb 210 and timetable-db.pdb 212 on the PDA 104 upon synchronization with the Imagebase Ibase2003.mdb 202 (FIG. 3). As discussed above, the Imagebase Ibase2003.mdb 202 will be updated to reflect the changes that were updated by the teacher.

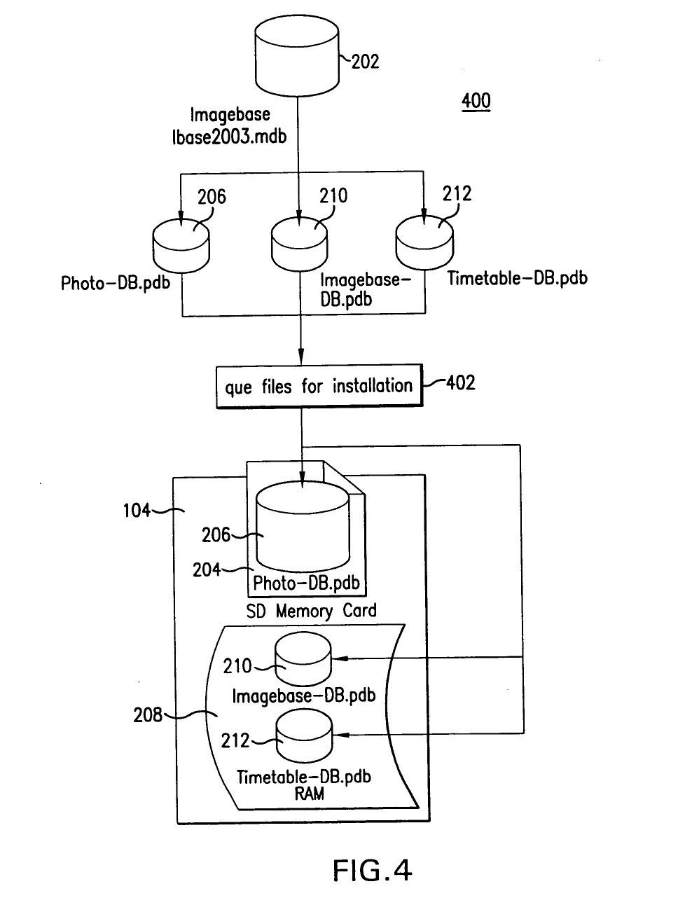

In prior art systems, databases with image data have been configured as read-only database. That is, users of the PDAs could not write to a database that stored student images on a PDA. As discussed in the background section, a shortcoming of the prior art systems is that databases with image data had to be sent back to a vendor in order to update the photo database. The Mobile Imagebase, however, overcomes this shortcoming by creating a way to dynamically write to the photo-db.pdb 206 and avoid the inconvenience of having to send the photo-db.pdb 206 and/or the memory card 204 to a vendor to update it (FIG. 4).

With reference now to FIG. 3 of the drawings, there is illustrated therein a block diagram showing the synchronization of the imagebase-db.pdb 210 and timetable-db.pdb 212, generally designated by the reference numeral 300. The synchronization of the imagebase-db.pdb 210 and timetable-db.pdb 212 is made possible by the Mobile Imagebase Conduit 302. The Mobile Imagebase Conduit 302 is a direct library link program (.dll) that operates when a synchronization function is performed between the PDA 104 and Imagebase Ibase2003.mdb 202. The Mobile Imagebase Conduit 302 performs both user and record level synchronization between the imagebase-DB.pdb 210 and timetable-db.pdb 212 and the Imagebase Ibase2003.mdb 202. The Mobile Imagebase Conduit 302 synchronizes all demographic data and timetable information between the Imagebase Ibase2003.mdb 202 and the imagebase-db.pdb 210 and timetable-db.pdb 212. As seen in FIG. 3 the imagebase-db.pdb 210 and timetable-db.pdb 212 are contained in the RAM 208 of the PDA 104. Student images are not transferred to the photo-db.pdb 210 through the Mobile Imagebase Conduit 302 because of the architecture of the memory card 204. Doing so would involve a read/write action to the memory card which would severely hinder performance of the Mobile Imagebase Conduit 302.

As discussed, the data that is organized and stored by the Mobile Imagebase is synchronized at the record level. Each record can have 3 states associated with it: (1) modified, (2) new or (3) no change. If a record has been added to one of the databases then it is flagged as new, and if it is edited then it is flagged as modified. A new status always supersedes a modified status. The Imagebase Ibase2003.mdb 202 in the central computer 102 has precedence over the databases in the PDAs 104 in case of a conflict. That is, if both records have been altered for the same student, then the Imagebase Ibase2003.mdb 202 will take precedence over the alteration reflected in the mobile databases.

If any changes are made to a record, the Mobile Imagebase propagates the changes to all other users' databases. That is, the Mobile Imagebase Conduit 302 and Imagebase Ibase2003.mdb 202 also performs synchronization at the user level. Mobile Imagebase tracks changes made to a record at a user level and ensures that all users' Mobile Imagebase databases are updated appropriately during the next synchronization. For example, if a school administrator changes a record associated with a student's emergency contact information in that school administrator's PDA 104, then the Mobile Imagebase not only makes the change in the Imagebase Ibase2003.mdb 202, but it also makes the change to all other databases in the various PDAs 104 in the network 100.

Mobile Imagebase can track changes for up to 16 unique users by way of bitwise masking of a status field in the imagebase-db.pdb 210. In one embodiment, the status field may be a long integer (32 bit integer). Mobile Imagebase only requires 2 bits per user to track a modified status and a new status, where a first value may represent the modified status and a second value may represent the new status. Mobile Imagebase is therefore able to track 16 independent users (304) using a 32 bit integer. Status may be obtained by performing a shift left (to embed value) or a shift right (to decode value) bitwise operation of ((UserNum-1)*2), where UserNum represents the current user from 1 to 16.

With reference now to FIG. 4 of the drawings, there is illustrated therein a block diagram showing the synchronization of the imagebase-db.pdb 210, timetable-db.pdb 212, and photo-db.pdb 206 generally designated by the reference numeral 400. The synchronization process depicted in FIG. 4 shows how the Mobile Imagebase exports the three databases and synchronizes the data, including the image data, with the data in the PDAs 104. First, the Mobile Imagebase exports all Mobile Imagebase database files, e.g., photo-db.pdb 206, imagebase-db.pdb 210, and timetable-db.pdb 212 from Imagebase Ibase2003.mdb 202. The Mobile Imagebase converts the data into .pdb format including the images and writes the records in order of student number. It is to be understood that the Mobile Imagebase is not to be limited to the .mdb and .pdb file types and that the principles disclosed herein are applicable to all available database and file types.

In one embodiment, the images are converted into a PDA compatible format, e.g., Palm compatible format, that makes use of a 256 color optimized bitmap where all image byte data is converted from little endian format on the central computer 102 to big endian format on the PDA 104. Images may be stored in a BLOB field within a table in the Imagebase Ibase2003.mdb 202. To transfer these images to the PDA 104, an export routine is performed. The export routine creates the imagebase-db-pbd 210, timetable-db.pdb 212 and the photo-db.pdb 206. During the export routine, each student record is iterated through and written to photo-db.pdb 206 (student number and image data in bitmap format). In one embodiment, the image information may then be converted from a 16 bit Windows palette found in the Imagebase Ibase2003.mdb 202 to that of a 256 bit optimized PDA bitmap. This procedure involves iterating through each pixel of the image and finding the closest corresponding RGB pixel color found in the workspace of the PDA. Any pixel information including hexadecimal color information may be converted from little endian byte format to big endian byte format for use on the PDA. In addition to the raw image information, the bitmap header information is populated accordingly. Photo-db.pdb 206, imagebase-db.pdb 210, and timetable-db.pdb 212 are then queued for transfer to the PDA 104 using an installer program 402. As seen in FIG. 4 the databases are then copied into their respective locations on the PDA 104. That is, photo-db.pdb 206 is stored on the SD (secure data) memory card 204, while imagebase-db.pdb 210 and timetable-db.pdb 212 are stored in a fashion so that they are made available for RAM processing 208.

Synchronization of demographic and timetable data (FIG. 2) may be transferred seamlessly via the Mobile Imagebase Conduit 302, but not image data.

The transfer of an image requires the re-exportation of the entire photo-db.pdb 206 out of Imagebase Ibase2003.mdb 202. The mechanism to perform the exportation is built into Mobile Imagebase. This feature gives users of the Mobile Imagebase the ability to add new students and their images to the Imagebase Ibase2003.mdb 202 and then dynamically transfer that data to the PDAs 104. Mobile Imagebase allows for images to be imported into the Imagebase Ibase2003.mdb 202 by either loading a digital file or using a PhotoAdd component. PhotoAdd allows for a direct connection to be established with a digital camera for capturing and loading images into Imagebase Ibase2003.mdb 202. PhotoAdd is useful for adding new students or missed students. When PhotoAdd is used in conjunction with the Mobile Imagebase Conduit 302, students images may be readily transferred to the PDAs 104. If a school gets a new student, it does not have to send the database that stores the students' images, e.g., photo-db.pdb 206 stored on the SD memory card 204, out to a vendor to be updated. The architecture of memory cards, e.g, SD memory cards 204, does not allow for a Palm HotSync operation (or other similar operations) to transfer the data. SD memory cards are not random-access friendly, i.e., SD memory cards can be written to, but only in a very slow manner. The export feature of the Mobile Imagebase overcomes this problem by allowing for the dynamic synchronization by re-exporting the three database files to the PDA 104.

In practice, the export operation depicted in FIG. 4 can be performed less frequently than the synchronization process via the Mobile Imagebase Conduit 302 in FIG. 3. The frequency of exporting the image files will likely depend on the nature of the student population. A large student population that is constantly in flux, may require daily exports, while a smaller school may require less frequent exports. It is to also be understood that in certain embodiments the Mobile Imagebase can be used in multiple schools, e.g., a school district.

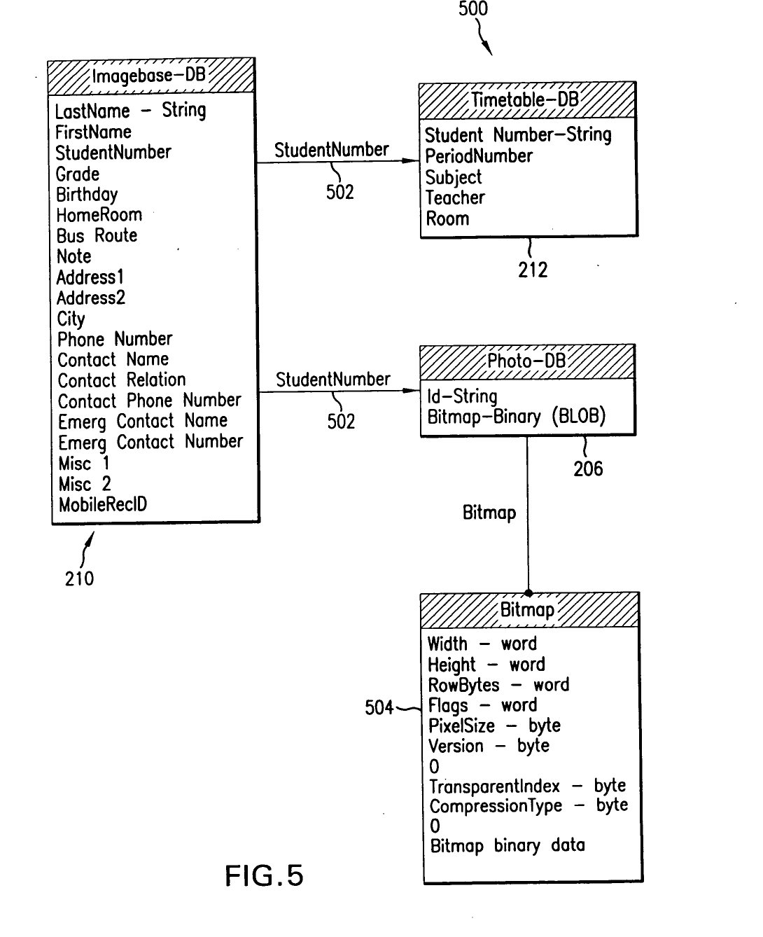

With reference now to FIG. 5 of the drawings, there is illustrated therein the definitions of the various databases utilized by the Mobile Imagebase, generally designated by the reference numeral 500. As seen in FIG. 5, the imagebase-db.pdb 210 may contain at least the following string fields: LastName, FirstName, StudentNumber, Grade, Birthday, HomeRoom, Bus Route, Note; Address 1, Address2, City, Phone Number, Contact Name, Contact Relation, Contact Phone Number, Emerg Contact Name, Emerg Contact Number, Misc 1, Misc 2 and MobileRecID. As discussed above, the databases are indexed by the student number 502. Timetable-DB.pdb 212 may contain at least the following string fields:

Student Number, PeriodNumber, Subject, Teacher and Room. photo-db.pdb 206 may contain a string ID and the image data stored in a binary large object (“BLOB”) format. The Bitmap 504 may contain the following fields: Width, Height, RowBytes, and Flags; PixelSize, Version, 0, TransparentIndex, CompressionType, 0 and Bitmap binary data. The students' image may be in the format of an 80×200 pixel Bitmap, 256 color Palm optimized palette.

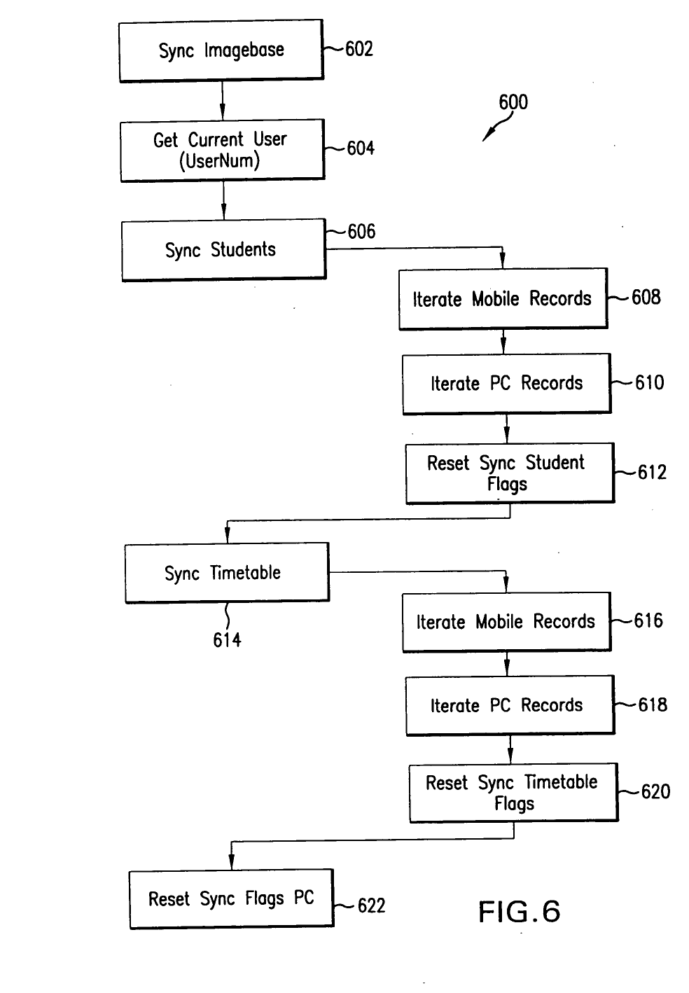

The flow charts of FIGURES. 6, 7 and 8 show embodiments of the architecture, functionality, and operation of possible implementations of software that may be used to operate the Mobile Imagebase described above. In this regard, each block may represent a module, segment, or portion of code, which comprises one or more executable instructions for implementing the specified logical functions. It should also be noted that in some implementations, the functions noted in the blocks may occur out of the order indicated by the figures. For example, two blocks shown in succession may in fact be executed substantially concurrently or the blocks may sometimes be executed in the reverse order, depending upon the functionality involved, as would be understood by those reasonably skilled in the art.

With reference now to FIG. 6 of the drawings, there is illustrated therein a process flowchart depicting the Mobile Imagebase Conduit 302, generally designated by the reference numeral 600. As discussed above, the Mobile Imagebase Conduit 302 synchronizes two databases, the imagebase-db.pdb 210 and timetable-db.pdb 212. The Sync Students 606 and Sync Timetable 614 steps are a series of operations performed by the Mobile Imagebase Conduit 302 to transfer information between the imagebase-db.pdb 210 and timetable-db.pdb 212 and the Imagebase Ibase2003.mdb 202. As set forth in FIG. 6, synchronization occurs depending upon the status flags set in the MobileStatus field on the PDA 104.

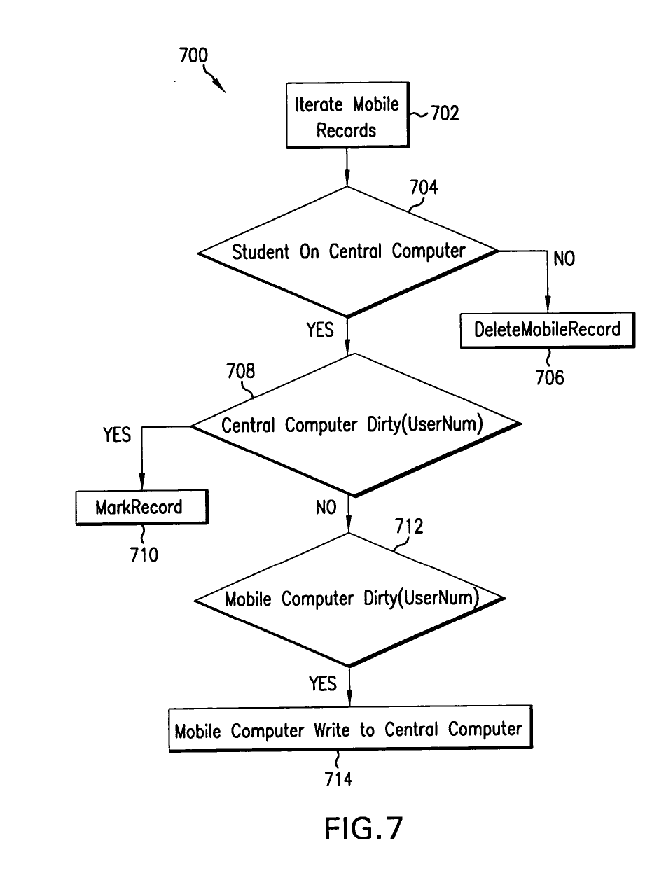

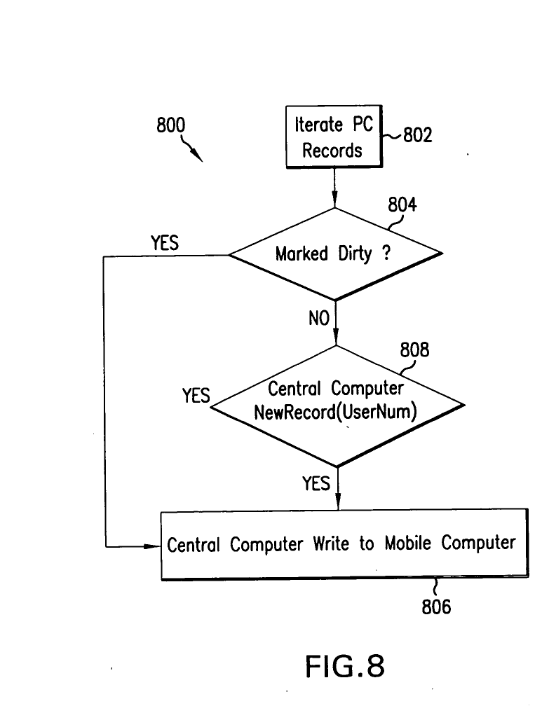

The method begins at step 602 Sync Imagebase. Next, the current user number (UserNum) is obtained (step 604). As discussed above, UserNum represents the current user, e.g., teacher or school administrator, from 1 to 16. Then the Sync Students operation is initiated (step 606). During the Sync Students operation three steps are performed: Iterate Mobile Records (step 608), Iterate PC Records (step 610), and Reset Sync Student Flags (step 612). T he iteration functions check to determine whether there are any dirty, or modified, records in the databases. These functions are detailed in FIGS. 7 and 8. Resetting the flags clears the MobileStatus field so that the modified or new flags for the current user are cleared; thus, no future action will occur for that record.

Next the Sync Timetable operation is performed (step 614). The Sync Timetable operation also contains three steps: Iterate Mobile Records (step 616), Iterate PC Records (step 618), and Reset Sync Timetable Flags (step 620). Similar to the functions performed by Sync Students 606, the iteration functions of the Sync Timetable operation 614 check to determine whether there are any dirty, or modified, records in the databases. These functions are detailed in FIGS. 7 and 8. Resetting the timetable flags clears the MobileStatus field so that the modified or new flags for the current user are cleared; thus, no future action will occur for that record. Lastly, the sync flags on the central computer 102 are reset as appropriate (step 622). This operation assures synchronization at the user level.

One of the unique aspects of the Mobile Imagebase Conduit 302 is the user level synchronization. If a record is edited a flag indicates that the record has been changed. Then when a users' PDA 104 is synchronized with the Imagebase Ibase2003.mdb 202, the Mobile Imagebase iterates, or goes through, all the records and finds the records where the flag indicates that the record has been edited. The records that have been changed are then transferred over to the respective database.

For example, a record that has been flagged as changed in the PDA 104 will be mirrored to the Imagebase Ibase2003.mdb 202. Similarly, a record that has been flagged as changed in the Imagebase Ibase2003.mdb 202 will be mirrored to the PDA 104. Thus, a flagged record in Imagebase Ibase2003.mdb 202 will remain in the dirty status to each unique mobile user 104 until that user has synchronized with the Imagebase Ibase2003.mdb 202.

With reference now to FIG. 7 of the drawings, there is illustrated therein a process flowchart depicting the process of iterating mobile records, generally designated by the reference numeral 700. The method begins at step 702. First, the Mobile Imagebase determines whether or not the particular student for which the record is being iterated is on the Imagebase Ibase2003.mdb 202 in the central computer 102 (step 704). If the record is not on the PC 102, the mobile record in the PDA 104 is deleted (step 706). This is because the central computer 102 and Imagebase Ibase2003.mdb 202 always have precedence over the mobile PDAs 104 in case of a conflict.

If the particular student is on the PC, it is determined whether or not the PC is dirty (step 708). PC Dirty(UserNum) 708 i s a function that determines if the current record has been modified and flagged for synchronization for the current user. If the current record has been modified and flagged for synchronization for the current user, it is marked on the central computer 102 (step 710). Records may be marked dirty (and not immediately copied) to speed up the Mobile Imagebase Conduit 302. Using this process allows for all records to be iterated on the PDA 104 and then only a subset of all the marked dirty records on the Imagebase Ibase2003.mdb 202 to be transferred in bulk as required. By using this method the required record within the Imagebase-db 210 on the PDA 104 can be quickly located.

If it is found that there are no dirty records on the central computer 102 for that particular user number, then it must be determined whether or not there are any dirty records on the PDA 104 (step 712). If there are dirty records on the PDA 104, those records are then written to the Imagebase Ibase2003.mdb 202.

With reference now to FIG. 8 of the drawings, there is illustrated therein a process flowchart depicting the process of iterating PC records, generally designated by the reference numeral 800. The method begins at step 802. First it is determined whether there are any records in the central computer 102 database Imagebase Ibase2003.mdb 202 that are marked dirty (step 804). If there are any dirty records, those dirty records are written to the PDA 104. If there are not any dirty records, it is next determined if there are any new records in Imagebase Ibase2003.mdb 202 that have not yet been transferred to the unique user (step 808).

The Mobile Imagebase can determine whether or not each mobile PDA device 104 has received any newly added records by synchronizing on a user level. For example, a principle of a school may only synchronize his PDA 104 on a weekly basis, while a teacher may synchronize his PDA 104 on a daily basis. Regardless of the timing or frequency of synchronization, both the principle and teacher will propagate their respective changed records to each other, and to other users of the Mobile Imagebase.

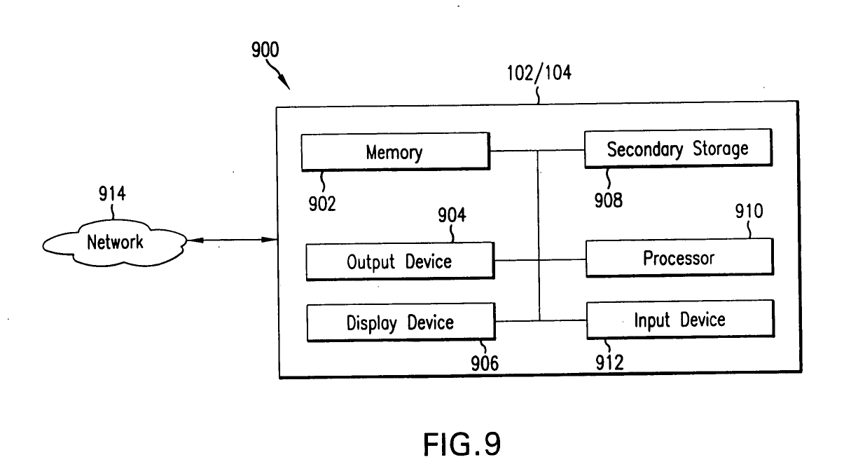

FIG. 9 illustrates exemplary hardware components that may comprise the central computer 102 and PDAs 104 that are used by the Mobile Imagebase described above. The central computer 102 or PDA 104 may include a connection with a network 914 such as the Internet or other type of computer or telephone networks. The connection may be a wireless connection. A wireless connection may be used to synchronize the central computer 102 and PDAs 104. The central computer 102 and PDAs 104 used by the Mobile Imagebase typically include a memory 902, a secondary storage device 908, a processor 910, an input device 912, a display device 906, and an output device 904.

The central computer 102 may be a general purpose computer system which is programmable using a high level computer programming language, such as “Java,” “C,” “C++” “Pascal,” “Visual Basic” or other language. The computer system may also be specially programmed, special purpose hardware. In a general purpose computer system, the processor 910 is typically a commercially available processor, of which the series ×86 processors, including a Pentium processor using MMX extensions available from Intel, and the 680×0 series microprocessors available from Motorola are examples. Many other processors are available. Such a microprocessor executes a program called an operating system, of which Windows95, WindowsNT, Windows2000, WindowsXP, UNIX, DOS and VMS are examples, which controls the execution of other computer programs and provides scheduling, debugging, input/output control, accounting, compilation, storage assignment in a file system containing named files of data, data management and memory management, communication control, protection and related services. The PDA 104 similarly uses an operating system to manage the execution of other programs operating on the PDA 104, e.g., the databases described above. There exists many PDA manufacturers and PDA operating systems, of which Palm based hardware and software is an example that may utilize the principles disclosed herein. In addition, there exists various processors that are currently utilized by PDAs 104. A commonly used example is the OMAP1510 processor manufactured by Texas Instruments.

The processor 902 and operating system define a computer platform for which application programs in high-level programming languages are written. It should be understood the other embodiments may employ other computer platforms, processors, or high-level programming languages. Additionally, the central computer 102 may be a multiprocessor computer system or may include multiple computers connected over a computer network.

The memory 902 may include random access memory (RAM) or similar types of memory. The secondary storage device 908 may include a SD memory card 204, hard disk drive, floppy disk drive, CD-ROM drive, magnetic disk, flash memory, tape or other types of non-volatile data storage, and may correspond with various databases or other resources. The disk may be removable, known as a floppy disk, or permanent, known as a hard drive. A disk has a number of tracks in which signals are stored, typically in binary form, i.e., a form interpreted as a sequence of one and zeros. Such signals may define, for example, an application program to be executed by the microprocessor, or information stored on the disk to be processed by the application program.

The processor 910 may execute information stored in the memory 902, the secondary storage 908, or received from the Internet or other network 914.

Typically, in operation, the processor 910 causes data to be read into an integrated circuit memory element, which is typically a volatile, random access memory such as a dynamic random access memory (DRAM) or static memory (SRAM). The integrated circuit memory element allows for faster access to the information by the processor than does the disk. The processor generally manipulates the data within the integrated circuit memory and copies the data to and from the disk if the data is not being used. A variety of mechanisms are known for managing data movement between the disk and the integrated circuit memory element, and any such mechanisms may be employed. Similarly, any memory system may be employed.

The input device 912 may include any device for entering data into the central computer 102 and PDA 104, such as a stylus, keyboard, keypad, cursor-control device, touch-screen, or microphone. The display device 905 may include any type of device for presenting visual image, such as, for example, a computer monitor, flat-screen display, display panel, or other display. The output device 904 may include any type of device for presenting data in hard copy format, such as a printer, and other types of output devices including speakers or any device for providing data in audio form. The central computer 102 and PDA 104 can possibly include multiple input devices, output devices, and display devices.

Although the central computer 102 or PDA 104 is depicted with various components, one skilled in the art will appreciate that the central computer 102 and PDA 104 can contain additional or different components. In addition, although aspects of an implementation consistent with the present disclosure are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; an infrared port; or other forms of RAM or ROM. The computer-readable media may include instructions for controlling the central computer 102 and PDA 104 to perform a particular method.

The foregoing description of the present invention provides illustration and description, but is not intended to be exhaustive or to limit the invention to only the embodiments disclosed. Modifications and variations are possible consistent with the above teachings or may be acquired from practice of the invention. For example, the above embodiments have been illustrated in the context of a school environment. It is to be understood that the school environment is only one of many environments in which the Mobile Image base may be utilized. The applications of the Mobile Imagebase may extend to any environment in which ready-access of individual information is needed. Examples may include: corporations, neighborhoods, churches or other religious organizations, clubs, work places, teams, sports organizations, a sports fan's use of image data for athletes, etc. Thus, it is noted that the scope of the invention is defined by the claims and their equivalents.

1. A method for synchronizing database records, said method comprising the steps of:
storing, on a central computer, demographic data, class schedule data, and image files in a master database;
synchronizing the demographic data stored on said central computer with a first database in a mobile computer; and
synchronizing the class schedule information stored on said central computer with a second database in said mobile computer, wherein said steps of synchronizing the demographic data and synchronizing the class schedule information are performed by a conduit program between said central computer and said mobile computer.

2. The method according to claim 1, wherein said conduit program determines a user number associated with said mobile computer.

3. The method according to claim 2, wherein said conduit program synchronizes the demographic data and class schedule data on a user lever.

4. The method according to claim 3, wherein said conduit program synchronizes a plurality of users via a 32 bit integer where each user is represented by 2 bits.

5. The method according to claim 1, wherein said conduit program iterates through the records in the first database and second database of the mobile computer.

6. The method according to claim 5, wherein said conduit program marks records in the central computer that have changed as marked records.

7. The method according to claim 5, wherein said conduit program writes any changed records in said mobile computer to said central computer.

8. The method according to claim 5, wherein said conduit program iterates through the records of the central computer.

9. The method according to claim 8, wherein said conduit program determines if there are any marked records and writes said marked records to said mobile computer.

10. The method according to claim 9, wherein said conduit program determines if there are any new records and writes said new records to said mobile computer.

11. The method according to claim 1, further including the step of:
synchronizing the image files stored on said central computer with a third database in said personal digital assistant.

12. The method according to claim 11, wherein said step of synchronizing said image files further includes the steps of:
exporting said demographic data, class schedule information and image files; and
installing said demographic data, class schedule information and image files on said personal digital assistant.

13. The method according to claim 12, wherein said demographic data and class schedule information are stored in random access memory of said personal digital assistant.

14. The method according to claim 12, wherein said image files are stored in a memory card of said personal digital assistant.

15. The method according to claim 12, wherein said step of exporting further includes the step converting data in said image file from little endian format on said central computer to big endian format on said mobile computer.

16. The method according to claim 15, wherein data in image file is in a 256 color optimized bitmap format.

17. The method according to claim 11, wherein said steps of synchronizing the image files, synchronizing the demographic data, and synchronizing the class schedule information are performed wirelessly.

18. A computer readable medium, said computer readable medium comprising instructions to cause a computer to:
store, in a master database, demographic data, class schedule data, and image files;
synchronize the demographic data stored on said master database with a first database in a mobile computer;
synchronize the class schedule information stored on said master database with a second database in said mobile computer; and
synchronize the image files stored on said master database with a third database in said mobile computer.

19. The computer readable medium according to claim 18, wherein said instructions of synchronizing the demographic data and synchronizing the class schedule information are performed by a conduit program.

20. The computer readable medium according to claim 20, wherein said instructions of synchronizing the image files stored on said master database with a third database in said mobile computer are performed by exporting said demographic data, class schedule information and image files, and installing said demographic data, class schedule information and image files on said mobile computer.

21. A method for synchronizing database records in a school, said method comprising the steps of:
populating a master database with student records and photographic images;
loading said master database onto a central computer;
transferring said student records and photographic images from said master database to a plurality of mobile computers; and
updating said student records and photographic images.

22. The method according to claim 21, further comprising the step of:
synchronizing said student records by use of a conduit program.

23. The method according to claim 22, further comprising the step of:
synchronizing said photographic images by exporting said photographic images from said master database to said plurality of mobile computers.
